(19) United States
(12) Patent Application Publication
(10) Pub. No.: US 2015/0008794 A1
(43) Pub. Date: Jan. 8, 2015

(54) PIEZOELECTRIC-TYPE ELECTROACOUSTIC CONVERSION DEVICE

(71) Applicant: NEC CASIO MOBILE COMMUNICATINS, LTD., Kanagawa (JP)

(72) Inventors: Yasuharu Onishi, Kanagawa (JP); Yukio Murata, Kanagawa (JP); Yuichiro Kishinami, Kanagawa (JP); Motoyoshi Komoda, Kanagawa (JP)

(73) Assignee: NEC CASIO MOBILE COMMUNICATIONS, LTD., Kanagawa (JP)

(21) Appl. No.: 14/379,366

(22) PCT Filed: Oct. 4, 2012
(86) PCT No.: PCT/JP2012/006376

§ 371 Date: Aug. 18, 2014

(30) Foreign Application Priority Data
Feb. 17, 2012 (JP) 2012-032890

(51) Int. Cl. H04R 17/00

(52) U.S. Cl. CPC H04R 17/00
USPC 310/326

(57) ABSTRACT

A lower surface of a circular support plate made of resin is fixed to an upper surface of a ring-shaped frame. A circular through hole is provided in a center portion of the support plate, a lower surface of a circular metal plate is fixed to a portion of an upper surface of the support plate positioned at the circumference of the through hole. An upper-groove is provided in a ring shape positioned inward of an upper surface of the metal plate. A shock absorbing member made of elastic materials is provided in the upper groove of the metal plate. A piezoelectric element is provided on a portion of the upper surface of the metal plate positioned inward from the shock absorbing member, and a portion of an upper surface of the shock absorbing member positioned on an inner periphery portion of the shock absorbing member.

### TECHNICAL FIELD

The present invention relates to a piezoelectric-type electroacoustic conversion device.

### BACKGROUND ART

In a conventional piezoelectric-type electroacoustic conversion device, a piezoelectric element is used in which electrode layers are provided on the upper surface and the lower surface of a circular piezoelectric element body Made of piezoelectric ceramics, and the electrode layer on the lower-surface side of the piezoelectric element is fixed to the central portion of the upper surface of a circular metal plate via an adhesive agent (for example, see Patent Document 1). Regarding the piezoelectric-type electroacccustic conversion device, when a voltage is applied between the both electrode layers of the piezoelectric element, the piezoelectric element vibrates with the metal plate in response to the applied voltage, and a sound is emitted in accordance with the applied voltage, whereby the piezoelectric-type electroacoustic conversion device is utilized as a speaker.

### PRIOR ART DOCUMENT

### Patent Document

Patent Document 1: JP 59-034800

### SUMMARY OF INVENTION

### Problem to be Solved by the Invention

However, regarding the above-described, conventional piezoelectric-type electroacoustic conversion device, there is a problem in that, when a shock due to a fall or the like is received, the piezoelectric element vibrates in response to the shock, and energy generated in the centrifugal direction of the piezoelectric element is transmitted to a metal plate at the outer periphery portion of the piezoelectric element by means of the motion of the expansion in the diameter of the piezoelectric element, (extension and contraction motion in the direction toward the outer periphery), and, as a result, stress on a boundary surface between the outer periphery portion of the piezoelectric element and the metal plate is concentrated, whereby the piezoelectric element, which includes piezoelectric ceramics having brittleness, may be damaged at a portion where the stress is concentrated. Also, the piezoelectric ceramics has a high mechanical quality factor (Mechanical Q), so that sound pressure level is high near-resonance frequencies, and whereas the sound pressure level is remarkably attenuated in the band other than the resonance frequencies, and there is a problem in that relatively large crests and troughs of the sound pressure occur with respect to a frequency sound pressure characteristic, whereby the flatness of frequency sound pressure characteristic is not considered to be good.

Accordingly, an object of the present invention is to provide a piezoelectric-type electroacoustic conversion device in which, even when a shock due to a fall or the like is received, a piezoelectric element can be made resistant to damage, and the flatness of a frequency sound pressure characteristic can be improved.

### Means for Solving the Problem

A piezoelectric-type electroacoustic conversion device according to the present, invention includes: a ring-shaped frame; a support plate an outer periphery portion of a lower surface of which is fixed to an upper surface of the frame, and which includes a -through hole at a. central portion thereof; a metal plate an outer periphery portion of a lower surface of which is fixed to a portion of an upper surface of the support plate positioned at a circumference of the through hole; a groove provided in a ring shape on an upper surface of the metal plate; a shock absorbing member provided in the groove of the metal plate; and a piezoelectric element wherein at least an outer periphery portion of a lower surface is fixed to an upper surface of the shock absorbing member.

### EFFECT OF THE INVENTION

According to the aspect of the present invention, even when a shock due to a fail or the like is received, the piezoelectric element can be made resistant to damage, and the flatness of a frequency sound pressure characteristic can be improved.

### BRIEF DESCRIPTION OF DRAWINGS

FIG. 1 is a plan view of a piezoelectric-type electroacoustic conversion device of a first embodiment of the present invention.

FIG. 2 is a cross-sectional view taken along the line II-II of FIG. 1.

FIG. 3 is a cross-sectional view of the piezoelectric-type electroacoustic conversion device, which is similar to that in FIG. 2, as a second embodiment of the present invention.

FIG. 4 is a diagram for describing frequency sound pressure characteristics.

### DESCRIPTION OF EMBODIMENTS

### First Embodiment

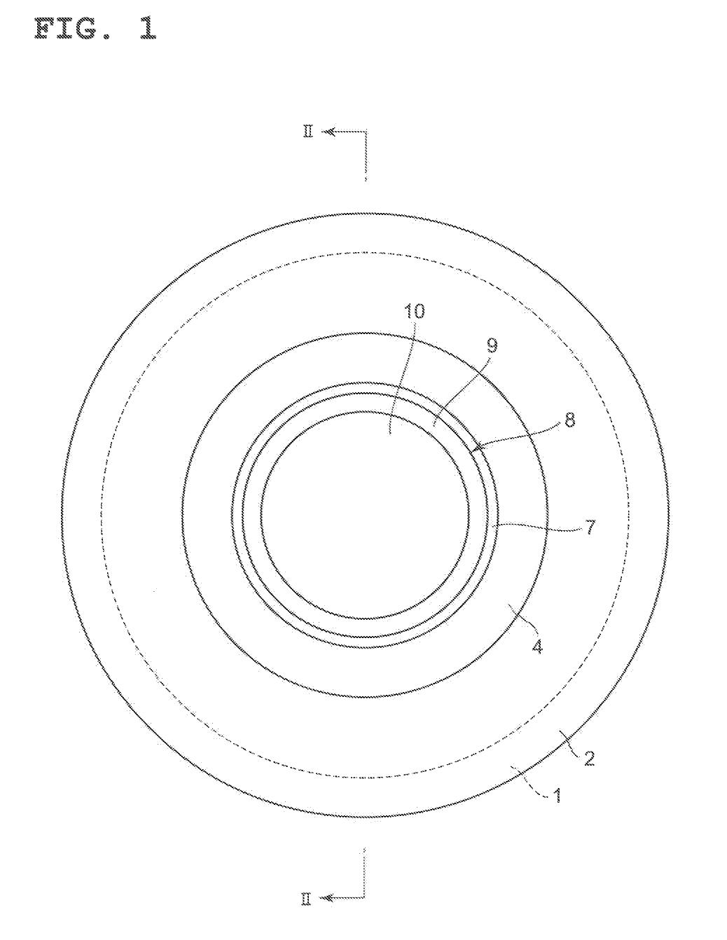

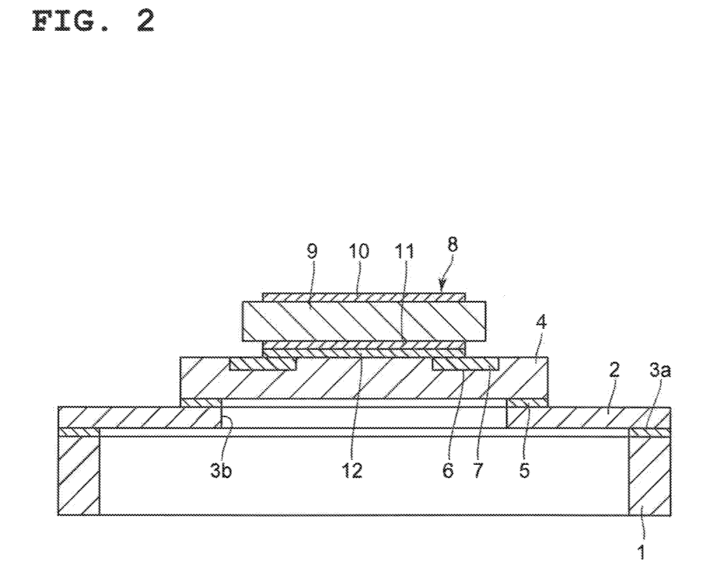

FIG. 1 illustrates a plan view of a piezoelectric-type electroacoustic conversion device of a first embodiment of the present invention, and FIG. 2 illustrates a cross-sectional view taken along the line II-II of FIG. 1. The piezoelectric-type electroacoustic conversion device includes a ring-shaped frame 1. An outer periphery portion of a lower surface of a circular support plate 2, made of resin such as polyethylene terephthalate and polyester, is fixed to an upper surface of the frame 1 via an adhesive agent 3. A circular through hole 3 is provided in the center portion of the support plate 2.

An outer periphery portion of a lower surface of a circular metal plate 4, made of stainless steel and the like, is fixed to a portion of an upper surface of the support plate 2 positioned at the circumference of the through hole 3 via an adhesive agent 5. A groove 6, whose cross section is formed in a rectangular shape, is provided in a ring shape and positioned inward from an outer periphery portion of an upper surface of the metal plate 4. A shock absorbing member 7, made of elastic materials such as a carbon-based material and poly urethane, is provided in the groove 6 of the metal plate 4. In this case, the upper surface of the shock absorbing member 7 is flush with the upper surface of the metal plate 4.

A piezoelectric element 8 is provided on a portion of the upper surface of the metal plate 4 positioned inward from the shock absorbing member 7, and on a portion of an upper surface of the shock absorbing member 7 positioned on an inner periphery portion of the shock absorbing member 7 and at a circumference of the portion of the upper surface of the metal plate 4. The piezoelectric element 8 is configured such that respective circular electrode layers 10 and 11 are provided on the upper surface and the lower surface of a circular piezoelectric element body 9, made of piezoelectric ceramics such as zirconate titanate salt and barium titanate. Then, the lower surface of the electrode layer 11 on the lower surface side of the piezoelectric element 8 is fixed via an adhesive agent 12 to the portion of the upper surface of the metal plate 4 positioned inward from the shock absorbing member 7, and the portion of the upper surface of the shock absorbing member 7 positioned on the inner periphery portion of the shock absorbing member 7 and at the circumference of the portion of the upper surface of the metal plate 4.

Now, in this piezoelectric-type electroacoustic conversion device, when a voltage is applied between the both electrode layers 10 and 11 of the piezoelectric element 8, the piezoelectric element 3 vibrates with the metal plate 4 and the support plate 2 in response to the applied voltage, and a sound is emitted in accordance with the applied voltage, whereby the piezoelectric-type electroacoustic conversion device is utilized as a speaker.

When a shock due to a fall or the like is received, the piezoeleetric element 8 vibrates in response to the shock, and energy generated in the centrifugal direction of the piezoelectric element 8 is transmitted to the shock absorbing member 7 at the outer periphery portion of the piezoelectric element 8 by means of the motion of the expansion in the diameter of the piezoelectric element 8, and the energy is absorbed by the shock absorbing member 7, whereby stress concentrated on a boundary surface between the outer periphery portion of the piezoelectric element 8 and the shock absorbing member 7 is spread, and the piezoelectric element 8, which includes the piezoelectric ceramics having brittleness, can be made resistant to damage.

Also, although the piezoelectric ceramics has a high mechanical quality factor, the mechanical quality factor of the piezoelectric element 8 can be reduced because a mechanical attenuation can be added to a portion where stress is concentrated, on the boundary surface between the outer periphery portion of the piezoelectric element 8 and the shock absorbing member 7, by utilizing the internal losses (mechanical attenuation) of the shock absorbing member 7, made of the elastic materials such as the carbon-based material and poly urethane, and therefore the flatness of a frequency sound pressure characteristic can be improved. Moreover, in this case, the support plate 2 made of resin and interposed between the frame 1 and the metal plate 4 can serve as a vibration amplification function which propagates the vibration of the piezoelectric element 8.

### Second Embodiment

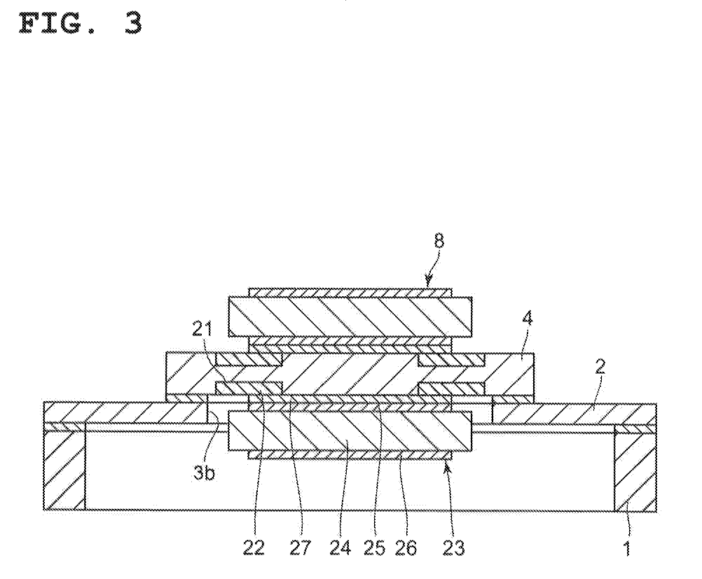

FIG. 3 illustrates a cross-sectional view of the piezoelectric-type electroacoustic conversion device, which is similar to that in FIG. 2, as a second embodiment of the present invention. This piezoelectric-type electroacoustic conversion device differs from the piezoelectric-type electroacoustic conversion device illustrated in FIG. 2 in terms of another piezoelectric element 23 provided on the lower surface of the metal plate 4. That is, a groove 21, whose cross section is formed in a rectangular shape, is provided in a ring shape and positioned inward from an outer periphery portion of the lower surface of the metal plate 4. A shock absorbing member 22, made of elastic materials such as the carbon-based material and polyurethane, is provided in the groove 21 of the metal plate 4. In this case, the lower surface of the shock absorbing member 22 is flush with the lower surface of the metal plate 4.

Another piezoelectric element 23 is provided on a portion of the lower surface of the metal plate 4 positioned inward from the shock absorbing member 22, and on a portion of a lower surface of the shock absorbing member 22 positioned on an inner periphery portion of the shock absorbing member 22 and at a circumference of the portion of the lower surface of the metal plate 4. The piezoelectric element 23 is configured such that respective circular electrode layers 25 and 26 are provided on the upper surface and the lower surface of a circular piezoelectric element body 24, made of piezoelectric ceramics materials such as zirconate titanate salt and barium titanate. Then, the upper surface of the electrode layer 25 on the upper surface side of the piezoelectric element 23 is fixed via an adhesive agent 27 to the portion of the lower surface of the metal plate 4 positioned inward from the shock absorbing member 22, and the portion of the lower surface of the shock absorbing member 22 positioned on the inner periphery portion of the shock absorbing member 22 and at the circumference of the portion of the lower surface of the metal plate 4. In this state, the piezoelectric element 23 is arranged in the through hole 3 of the support plate 2.

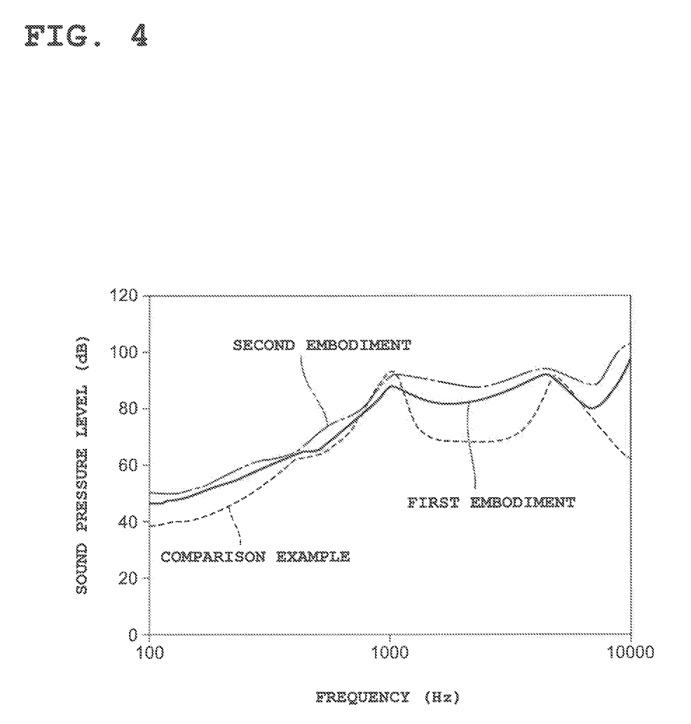

Herein, the frequency sound pressure characteristics were examined for the piezoelectric-type electroacoustic conversion device illustrated in FIG. 2, the piezoelectric-type electroacoustic conversion device illustrated in FIG. 3, and a piezoelectric-type electroacoustic conversion device, in which the shock absorbing member 7 in FIG. 2 is not provided (that is, the groove 6 is not provided, either and whereby the upper surface of the metal plate 4 is flat), for the purpose of comparison, and the results illustrated in FIG. 4 were acquired.

Here, in the case of the piezoelectric-type electroacoustic conversion device (comparative example), in which the shock absorbing member 7 in FIG. 2 is not provided, for the purpose of comparison, as illustrated by a dotted line in FIG. 4, there are two relatively large peaks in crests and troughs, therefore the flatness of the frequency sound pressure characteristic is not considered to be good. In contrast, in the case of the piezoelectric-type electroacoustic conversion device (first embodiment) illustrated in FIG. 2, as illustrated by a solid line in FIG. 4, the change between crests and troughs gently slopes in a band interposed between the two relatively large peaks illustrated by the dotted line in the comparative example, and the flatness of the frequency sound pressure characteristic is better.

In the case of the piezoelectric-type electroacoustic conversion device (second embodiment) illustrated in FIG. 3, as illustrated by a dashed-dotted line in FIG. 4, the change between crests and troughs gently slopes in the band interposed between the two relatively large peaks illustrated by the dotted line in the comparative example, and the flatness of the frequency sound pressure characteristic is better. Also, in the case of the second embodiment illustrated by the dashed-dotted line, as illustrated in FIG. 3, the two piezoelectric elements 8 and 23 are provided, so that the sound pressure level is high as a whole, as compared with the case of the first embodiment illustrated by the solid line.

Hereinafter, several embodiments of this invention are summarized in the Supplementary Motes described below.

### (Supplementary Note 1)

The present invention according to Supplementary Note 1 is a piezoelectric-type electroacoustic conversion device comprising: ring-shaped frame; a support plate an outer-periphery portion of a lower surface of which is fixed to an upper surface of the frame, and which includes a through hole at a central portion thereof; a metal plate an outer periphery portion of a lower surface of which, is fixed to a portion of an upper surface of the support plate positioned at a circumference of the through hole; a groove provided in a ring shape on an upper surface of the metal plate; a shock absorbing member provided in the groove of the metal plate; and a piezoelectric element wherein at least an outer periphery portion of a lower surface is fixed to an upper surface of the shock absorbing member.

### (Supplementary Note 2)

The present invention according to Supplementary Note 2 relates to the present invention claimed in Supplementary Note 1 of the piezoelectric-type electroacoustic conversion device, wherein the upper surface of the shock absorbing member is flush with the upper surface of the metal plate, and wherein the piezoelectric element is fixed to a portion of the upper surface of the metal plate positioned inward from the shock absorbing member, and a portion of the upper surface of the shock absorbing member positioned at a circumference of the portion of the upper surface of the metal plate.

### (Supplementary Note 3)

The present invention according to Supplementary Note 3 relates to the present invention claimed in. Supplementary Note 1 or 2 of the piezoelectric-type electroacoustic conversion device, wherein the shock absorbing member is made of an elastic member.

### (Supplementary Note 4)

The present invention according to Supplementary Note 4 relates to the present invention claimed in any one of Supplementary Notes 1 to 3 of the piezoelectric-type electroacoustic conversion device, wherein the support plate is made of resin.

### (Supplementary Note 5)

The present invention according to Supplementary Note 5 relates to the present invention claimed in any one of Supplementary Notes 1 to 4 of the piezoelectric-type electroacoustic conversion device, wherein a groove is provided in a ring shape on a lower surface of the metal plate, and wherein an another shock absorbing member is provided in the groove on a lower surface side of the metal plate, and wherein an another piezoelectric element is fixed to a portion of the lower surface of the metal plate positioned inward from the another shock absorbing member, and a portion of a lower surface of the another shock absorbing member positioned at a circumference of the portion of the lower surface of the metal plate.

### DESCRIPTION OF REFERENCE NUMERALS

1 frame
2 support plate
4 metal plate
6 groove
7 shock absorbing member
8 piezoelectric element
21 groove
22 shock absorbing member
23 piezoelectric element

1-5. (canceled)

6. A piezoelectric-type electroacoustic conversion device comprising:
a ring-shaped frame;
a support plate an outer periphery portion of a lower surface of which is fixed to an upper surface of the frame, and which includes a through hole at a central portion thereof;
a metal plate an outer periphery portion of a lower surface of which is fixed to a portion of an upper surface of the support plate positioned at a circumference of the through hole;
an upper groove provided in a ring shape on an upper surface of the metal plate;
a shock absorbing member provided in the upper groove of the metal plate; and
a piezoelectric element wherein at least an .outer periphery portion of a lower surface is fixed to an upper surface of the shock absorbing member.

7. The piezoelectric-type electroacoustic conversion device according to claim 6,
wherein the upper surface of the shock absorbing member is flush with the upper surface of the metal plate, and
wherein the piezoelectric element is fixed to a portion of the upper surface of the metal plate positioned inward from the shock absorbing member, and a portion of the upper surface of the shock absorbing member positioned at a circumference of the portion of the upper surface of the metal plate.

8. The piezoelectric-type electroacoustic conversion device according to claim 6, wherein the shock absorbing member is made of an elastic member.

9. The piezoelectric-type electroacoustic conversion device according to claim 6, wherein the support plate is made of resin.

10. The piezoelectric-type electroacoustic conversion device according to claim 6,
wherein a lower groove is provided in a ring shape on a lower surface of the metal plate, and
wherein an another shock absorbing member is provided in the lower groove on a lower surface side of the metal plate, and
wherein an another piezoelectric element is fixed to a portion of the lower surface of the metal plate positioned inward from the another shock absorbing member, and a portion of a lower surface of the another shock absorbing member positioned at a circumference of the portion of the lower surface of the metal plate.
